(19) United States
(12) Patent Application Publication
(10) Pub. No.: US 2023/0007565 A1
(43) Pub. Date: Jan. 5, 2023

(54) DEFAILT PATH ASSIGNMENT IN IAB NETWORKS

(71) Applicant: Telefonaktiebolanget LM Erisson (PUBL), Stockholm (SE)

(72) Inventors: Gunnar Mildh, SOLLENTUNA (SE); Ajmal Muhammad, SOLLENTUNA (SE); Filip Barac, HUDDINGE (SE); Oumer Teyeb, MONTRÉAL (CA)

(21) Appl. No.: 17/774,553

(22) PCT Filed: Nov. 6, 2020
(86) PCT No.: PCT/IB2020/060470

§ 371 Date: May 5, 2022

Related U.S. Application Data
(60) Provisional application No. 62/933,102, filed on Nov. 8, 2019.

(51) Int. Cl. H04W 40/22; H04W 28/02; H04W 40/24; H04W 76/15

(52) U.S. Cl. CPC H04W 40/22; H04W 28/0268; H04W 40/24; H04W 76/15; H04W 84/047

(57) ABSTRACT

According to some embodiments, a method performed by an integrated access and backhaul (IAB) donor control unit (CU) network node comprises obtaining a first mapping between a first traffic type and a first communication path. The first communication path is for communicating the first traffic type between the IAB donor CU network node and an IAB network node. The method further comprises transmitting the first mapping to the IAB network node.

### TECHNICAL FIELD

Embodiments of the present disclosure are directed to wireless communications and, more particularly, to default path assignment for integrated access and backhaul (IAB) networks.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) includes standards for integrated access and wireless access backhaul (IAB) in fifth generation (5G) new radio (NR). The usage of short range mmWave spectrum in NR creates a need for densified deployment with multi-hop backhauling. However, optical fiber to every base station is costly and sometimes not even possible (e.g., historical sites). The main IAB principle is using wireless links for the backhaul (instead of fiber) to enable flexible and dense deployment of cells without the need for densifying the transport network. Use case scenarios for IAB can include coverage extension, deployment of massive number of small cells and fixed wireless access (FWA) (e.g., to residential/office buildings). The larger bandwidth available for NR in mmWave spectrum provides opportunity for self-backhauling, without limiting the spectrum to be used for the access links. On top of that, the inherent multi-beam and multiple-input multiple-output (MIMO) support in NR reduce cross-link interference between backhaul and access links facilitating higher densification.

The IAB architecture may leverage the Central Unit (CU)/Distributed Unit (DU) split architecture of NR, where the IAB node hosts a DU part that is controlled by a central unit. The IAB nodes also have a Mobile Termination (MT) part to communicate with their parent nodes.

The specifications for IAB reuses some existing functions and interfaces defined in NR. In particular, MT, gNB-DU, gNB-CU, user plane function (UPF), access and management function (AMF) and session management function (SMF) as well as the corresponding interfaces NR Uu (between MT and gNB), F1, NG, X2 and N4 are used as baseline for the IAB architectures. Modifications or enhancements to these functions and interfaces for the support of IAB is described in more detail in the context of the architecture discussion. Additional functionality, such as multi-hop forwarding, is included in the architecture discussion as it is necessary for the understanding of IAB operation and because certain aspects may require standardization.

The Mobile-Termination (MT) function is a component of the IAB node. As used herein, MT is referred to as a function residing on an IAB-node that terminates the radio interface layers of the backhaul Uu interface toward the IAB-donor or other IAB-nodes.

FIG. 1 illustrates a high-level architectural view of an IAB network. FIG. 1 is a reference diagram for IAB in standalone mode, which contains one IAB-donor and multiple IAB-nodes. The IAB-donor is treated as a single logical node that comprises a set of functions such as gNB-DU, gNB-CU-CP, gNB-CU-UP and potentially other functions. In a deployment, the IAB-donor can be split according to these functions, which can all be either collocated or non-collocated as allowed by 3GPP NG-RAN architecture. IAB-related aspects may anise when such a split is exercised. Also, some of the functions presently associated with the IAB-donor may eventually move outside of the donor in case it becomes evident that they do not perform IAB-specific tasks.

The baseline user plane and control plane protocol stacks for IAB are illustrated in FIGS. 2 and 3A-3C.

FIG. 2 is a block diagram illustrating a baseline UP protocol stack for IAB. FIGS. 3A-C are block diagrams illustrating a baseline CP protocol stack for IAB. As illustrated, the chosen protocol stacks reuse the current CU-DU split specification, where the full user plane F1-U (GTP-U/UDP/IP) is terminated at the IAB node (like a normal DU), and the full control plane F1-C (F1-AP/SCTP/IP) is also terminated at the IAB node (like a normal DU). In the illustrated examples, Network Domain Security (NDS) is used to protect both UP and CP traffic (IPsec in the case of UP, and DTLS in the case of CP). IPsec may also be used for the CP protection instead of DTLS (in this case no DTLS layer is used).

A protocol layer referred to as Backhaul Adaptation Protocol (BAP) in the IAB nodes and the IAB-donor is used for routing of packets to the appropriate downstream/upstream node and also mapping the UE bearer data to the proper backhaul radio link control (RLC) channel (and also between ingress and egress backhaul RLC channels in intermediate IAB nodes) to satisfy the end to end QoS requirements of bearers.

Routing and bearer mapping (e.g., mapping of backhaul RLC channels) are adaptation layer functions. The transmit part of the adaptation layer performs routing and bearer mapping, and the receive part of the adaptation layer performs bearer demapping. Service data units (SDUs) are forwarded from the receive part of the adaptation layer to the transmit part of the adaptation layer (for the next hop) for packets that are relayed by the IAB node.

BAP includes a DU part configured by F1-AP and a MT part configured by radio resource control (RRC). A BAP DU part and MT part each has one transmitter and one receiver. The BAP Routing ID (carried in the BAP header) consists of BAP address and BAP path ID. Each BAP address defines a unique destination (unique for IAB network of one donor, either an IAB access node, or the IAB donor). Each BAP address can have one or multiple entries in the routing table to enable local route selection. Multiple entries are for load balancing or re-routing at radio link failure (RLF). Each BAP Routing ID has only one entry in the routing table. The BAP address of the IAB node is used to differentiate traffic to be delivered to upper layers from traffic to be delivered to egress RLC layer.

For routing and bearer mapping of a packet retrieved from RLC layer, the IAB-node may be configured with the following mappings: BAP routing ID in BAP header to egress link (routing table); and ingress RLC channel to egress RLC channel (bearer mapping). For the selection/addition of a BAP routing ID as well as routing and bearer mapping for a packet retrieved from upper layers, the IAB-node and IAB donor may be configured with the following mappings: upper layer information to BAP Routing ID in BAP header; BAP routing ID in BAP header to egress link; and upper layer information to egress RLC channel.

With respect to the BAP header, the routing ID is 13 bits, there is a C/D bit, and the length of the BAP address and BAP path ID sub-fields of the BAP routing ID are fixed/predefined. For the downlink, BAP address is 10 bits and BAP path ID is 3 bits. The specification may not restrict configuration of routing ID and its components; thus the network may have to ensure that e.g. there is no path confusion.

FIG. 4 illustrates a sample header for the data PDU, where the MSB indicates whether it is a control or data header and then a few reserve bits for flags and future compatibility.

The radio bearers carrying CP/UP traffic for the MT functionality of an IAB node are handled separately from the backhaul RLC channels. Note that the backhaul RLC channels are used to carry traffic to/from the IAB DU functionality, which could either be intended for the UEs served by the IAB node or for the child IAB nodes. The traffic of child IAB nodes and UE served by IAB DU are handled separately by employing different logical channel IDs.

FIGS. 5 and 6 illustrate the flow of packets in the downlink direction. FIG. 5 illustrates an example of bearer mapping in IAB nodes for downstream transmission. FIG. 6 illustrates an example of the functions performed by BAP entities for downstream transmission.

For downlink, when a packet arrives at the IAB donor DU (from the donor CU) and is processed first by the upper layers (because there is no MT BAP layer at the donor DU), then if the packet is destined to UEs directly connected to the IAB donor DU or it is an F1-AP traffic destined at the IAB donor DU, the packet is forwarded to higher layers (IP/UDP/GTP-U for UP, IP/SCTP/F1-AP for CP). Otherwise (i.e., it is to be forwarded further downstream), the packet is forwarded to the DU BAP layer.

When a packet arrives at an IAB node (from a parent IAB node or IAB donor DU) via backhaul RLC channels, the packet is processed first by the MT BAP layer. If the packet is destined to UEs directly connected to the IAB node or F1-AP traffic destined at the IAB node's DU, the packet is forwarded to higher layers (IP/UDP/GTP-U for UP, IP/SCTP/F1-AP for CP). Otherwise (i.e., it is to be forwarded further downstream), it is forwarded to the DU BAP layer.

When a packet is forwarded to the DU-BAP layer, the DU BAP determines which route (i.e., to which child node) the packet is to be forwarded to and which backhaul RLC channel within that route will be used for forwarding the packet downstream based on the routing and bearer mapping table configured in the BAP layer by the IAB-donor CU.

FIGS. 7 and 8 illustrate the uplink direction. FIG. 7 is an example of bearer mapping in IAB nodes for upstream transmission. FIG. 8 is an example of the functions performed by BAP entities for upstream transmission.

For uplink, when a packet arrives at the IAB donor DU (from a child IAB node) via backhaul RLC channels, the packet is processed first by the DU BAP layer and is forwarded to the donor CU (because the donor DU can be connected to at most one donor CU, there is no routing functionality required). When a packet arrives at an IAB node in the uplink direction, if it is coming from a child IAB node via backhaul RLC channels, the packet is processed first by the DU BAP layer and, because every uplink packet is destined to be forwarded to the donor CU, it is passed on to the MT BAP layer. If the packet is from a UE connected directly to the IAB node, or it is an F1-AP traffic originating from the IAB node, the packet is processed first by the higher layers (IP/UDP/GTP-U for UP, IP/SCTP/F1-AP for CP) and is forwarded to the MT BAP layer. The MT BAP determines which route (i.e., which parent node) the packet is forwarded to and which backhaul RLC channel within the route will be used for forwarding the packet upstream.

IAB networks may use multipath communication. For example, the IAB-node may have redundant routes with the IAB-donor CU. Multiple paths are possible towards IAB node, via single or dual-connectivity, via one or multiple IAB-donor-DUs. The IAB-donor-CU can employ multipath for load balancing purposes, i.e., IAB-donor-CU can assign different paths to traffic belonging to different UEs served by an IAB node, or even different data radio bearers (DRBs) pertaining a UE.

The NR-DC framework may be reused for setting up multi-connectivity to IAB nodes. To use NR-DC for IAB nodes, however, some changes to the user plane aspects may be required. The reasons are that: the IAB nodes do not terminate packet data convergence protocol (PDCP) for F1-U traffic; the parent nodes to the IAB do not terminate F1-U for other IAB nodes (the forwarding is instead handled by the BAP layer); the architecture based on full F1-U support to the IAB node does not assume that there is any CU-UP function for traffic going to the IAB node (instead the DU handles IP routing); and the IP connectivity for non-IAB NR DC terminates in the UPF, which is not in line with the architecture for IAB network.

The user plane solutions for NR DC cannot be used in their current form to support multi-path connectivity to IAB nodes for F1-U traffic for several reasons, including lack of PDCP and CU-UP function for IAB nodes.

However, for an IAB network, a simplified version of NR DC for enabling multi-path communication may be used in line with existing architecture assumptions and avoids additional complexities such as tunnelling in tunnelling, with the following assumptions.

No split bearers are supported. This simplification avoids introduction of CU-UP functionality and re-ordering functionality, etc.

Each path is associated with a separate BAP Routing ID. This simplification avoids GTP tunnels to the parent nodes (carrying GTP tunnels to IAB node).

Each path is associated with its own IP address making the paths visible on the F1 application layer. This simplification makes it possible to set up paths through different donor DUs.

With the assumptions above, it is possible to support redundancy and rudimentary load balancing mechanism on the F1 application layer using features such as Multipath SCTP and smart load balancing of UE GTP tunnels to different paths.

For the user plane, it is possible to support a simplified version of NR-DC for IAB nodes, where each path is seen as a separate IP connection, which can be used by the application layer (F1-C/F1-U) for redundancy and rudimentary load balancing. This is described in more detail in TR 38.874 section 9.7.9.

When using NR-DC to support multi-connectivity for IAB nodes, the following assumptions are made. Only master cell group (MCG) or secondary cell group (SCG) backhaul bearers are supported. Split backhaul bearers are not supported. Each separate connection to a given IAB node is associated with a separate BAP identifier (e.g., address, path, address+path). Each separate connection is associated with at least one separate IP address to support multiple connections to use different donor DUs and allow selection of which connection to use by the end nodes (IAB node, donor CU). Selection of which connection to use is performed by the end nodes (IAB node, donor CU).

An example procedure for setting up multi-connectivity is illustrated in FIG. 9. FIG. 9 illustrates the starting scenario i.e., prior to setting up DC to IAB Node 1. IAB node 1 is connected via IAB node 2 and donor DU 1 towards the transport network layer (TNL). Donor DU 1 routes any packets destined to IP address 1 of IAB node 1 over the wireless backhaul to IAB node 2. The routing is based on BAP identifier 1 associated with IP address 1.

The donor CU determines e.g., based on IAB node 1 RRC level measurements, IAB node capabilities, etc., that IAB node 1 should establish dual connectivity to IAB node 3. Existing NR-DC RRC procedure is used to establish an SCG connection to IAB node 3. As part of this message the donor CU will configure the BAP identifier for the SCG link to IAB node 3, one or more backhaul RLC channels between the IAB node 1 and IAB node 3, and a new BAP route for the new connection.

After the new path is set up on the BAP, IAB node 1 may be allocated a new IP address 2 for the new connection. The result illustrated in FIG. 17 is that IAB node 1 is dual-connected, where each path has a separate IP address and can be used for F1-C/U application layer redundancy.

The donor CU responsible for setting up DC to the IAB node configures separate BAP Routing ID for each connection, enabling allocation of separate IP addresses for each connection.

When a child IAB node is connected to a parent IAB node which has support for multiple connections (as shown in FIG. 11 for IAB node 0), the child IAB node may use the multiple connections. For this reason, it is possible to assign such child IAB node multiple BAP Routing IDs. When the IAB node receives multiple Routing IDs it can request separate IP address for each BAP Routing ID.

An IAB child node connected to one or more upstream IAB nodes that uses NR-DC can be allocated multiple BAP IDs and IP addresses enabling it to use the multi-connectivity.

There currently exist certain challenges. As described above, in IAB networks the IAB donor CU is in control of paths towards the IAB node, where a path is identified by a BAP routing ID. An IAB node first connects to the network via RRC connection using its IAB-MT part. In this first phase of integration process, the IAB node may receive a number of IP addresses. Thereafter, F1-C communication is established, followed by F1-U communication establishment. The setup of the F1-C connection in IAB is triggered by the IAB node DU functionality (similar to legacy CU-DU split), by sending an F1 setup request message to the IAB donor CU, and the IAB donor CU replies with an F1 setup response, to confirm the F1-C establishment.

An IAB node may be several hops away from the IAB donor CU, where it could theoretically reach or communicate with the IAB donor CU via different paths. Some of the paths may be congested/overloaded and will take longer time for transferring the F1 setup message. Thus, it is important to indicate to an IAB node a suitable path for sending the F1 setup message to the IAB donor CU.

However, there is no mechanism for the IAB donor CU to indicate to an IAB node which primary path to use for sending F1 setup request and the subsequent F1-C communication between the two nodes.

### SUMMARY

As described above, certain challenges currently exist with path assignment in integrated access and backhaul (IAB) networks. Certain aspects of the present disclosure and their embodiments may provide solutions to these or other challenges. For example, particular embodiments include signaling that enables the IAB donor central unit (CU) control plane (CP) to configure the IAB distributed unit (DU) with a primary or default path for F1-C communication. Some embodiments include radio resource control (RRC) signaling from the IAB donor CU CP to IAB mobile termination (MT) indicating which primary/default path is to be used for F1-C communication.

Particular embodiments described herein enable the IAB donor CU to indicate a primary/suitable F1-C path to the IAB node. In general, particular embodiments include signaling to configure the primary/optimal path for F1-C communication carried over an IAB network.

According to some embodiments, a method performed by an integrated access and backhaul (IAB) donor control unit (CU) network node comprises obtaining a first mapping between a first traffic type and a first communication path. The first communication path is for communicating the first traffic type between the IAB donor CU network node and an IAB network node. The method further comprises transmitting the first mapping to the IAB network node.

In particular embodiments, the method further comprises obtaining a second mapping between a second traffic type and a second communication path. The second communication path is for communicating the second traffic type between the IAB donor CU network node and the IAB network node. The method further comprises transmitting the second mapping to the IAB network node.

In particular embodiments, the first communication path includes a first IAB donor distributed unit (DU) and the second communication path also includes the first IAB donor DU. The first communication path may include a first IAB donor distributed unit (DU) and the second communication path may include a second IAB donor DU different from the first IAB donor DU.

In particular embodiments, the IAB donor CU comprises two or more IAB donor CU control planes (CP) and the first communication path includes a first IAB donor CU CP and the second communication path also includes the first IAB donor CU CP. In some embodiments, the first communication path includes a first IAB donor CU CP and the second communication path includes a second IAB donor CU CP different from the first IAB donor CU CP.

In particular embodiments, the first traffic type and the second traffic type are the same traffic type and the first communication path comprises a primary communication path and the second communication path comprises a secondary communication path. In some embodiments, the first traffic type and the second traffic type are different traffic types and the first communication path comprises a primary communication path for the first traffic type and the second communication path comprises a primary communication path for the second traffic type.

In particular embodiments, the first traffic type comprises F1-C traffic. In some embodiments, the first traffic type comprises a plurality of traffic types.

In particular embodiments, the first communication path is identified by a backhaul adaptation protocol (BAP) route identifier.

According to particular embodiments, a method performed by an IAB network node comprises obtaining a first mapping between a first traffic type and a first communication path. The first communication path is for communicating the first traffic type between an IAB donor CU network node and the IAB network node. The method further comprises transmitting a communication of the first traffic type to the IAB donor CU network node using the first communication path. Obtaining the first mapping may comprise receiving the first mapping from the IAB donor CU network node.

In particular embodiments, the method further comprises obtaining a second mapping between a second traffic type and a second communication path. The second communication path is for communicating the second traffic type between the IAB donor CU network node and the IAB network node. The method further comprises transmitting a communication of the second traffic type to the IAB donor CU network node using the second communication path.

In particular embodiments, the first communication path includes a first IAB donor distributed unit (DU) and the second communication path also includes the first IAB donor DU. The first communication path may include a first IAB donor distributed unit (DU) and the second communication path may include a second IAB donor DU different from the first IAB donor DU.

In particular embodiments, the IAB donor CU comprises two or more IAB donor CU control planes (CP) and the first communication path includes a first IAB donor CU CP and the second communication path also includes the first IAB donor CU CP. In some embodiments, the first communication path includes a first IAB donor CU CP and the second communication path includes a second IAB donor CU CP different from the first IAB donor CU CP.

In particular embodiments, the first traffic type and the second traffic type are the same traffic type and the first communication path comprises a primary communication path and the second communication path comprises a secondary communication path. The first traffic type and the second traffic type may be different traffic types and the first communication path may comprise a primary communication path for the first traffic type and the second communication path may comprise a primary communication path for the second traffic type.

In particular embodiments, the first traffic type comprises F1-C traffic. In some embodiments, the first traffic type comprises a plurality of traffic types.

In particular embodiments, the first communication path is identified by a BAP route identifier.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments improve IAB operation because they enable proper configuration of a primary/default path for F1-C communication between the IAB node and IAB-donor, for both uplink and downlink packets. Particular embodiments include the corresponding RRC signaling. If no primary/default path is indicated, the IAB node may send the initial F1-C signaling via a path that was not optimal for the operation (e.g., a path containing multiple hops thereby increasing the IAB-DU setup time).

Additionally, by having the possibility to use a default/primary path when the IAB node cannot find matching information in the routing table for any given traffic that it is routing, the amount of signaling that is required to configure the IAB node may be reduced (e.g., IAB node routing/bearer tables do not need to be updated unless bearers have to be mapped to a path different from the primary/default path).

Additionally, though the network may have several paths available to a certain IAB node, some of them may not be preferable (e.g., some of the nodes on the paths are shared with other operators or leased from other operators), and thus may be used only when there is an overload/congestion on the other paths. Thus, the CU may configure such paths as backup paths rather than default paths to be used only under certain conditions (e.g., radio link failure or extreme latency on the primary path).

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a high-level architectural view of an integrated access and backhaul (IAB) network;

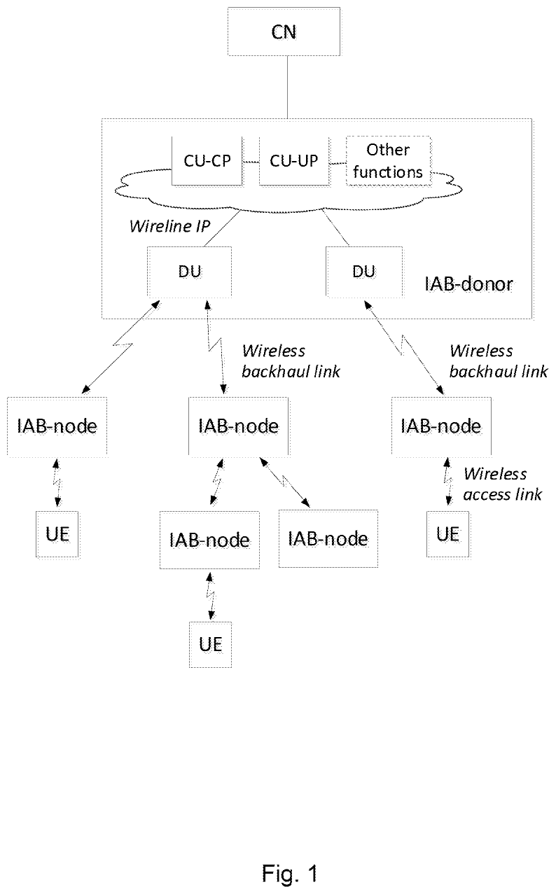

FIG. 2 is a block diagram illustrating a baseline user plane (UP) protocol stack for IAB;

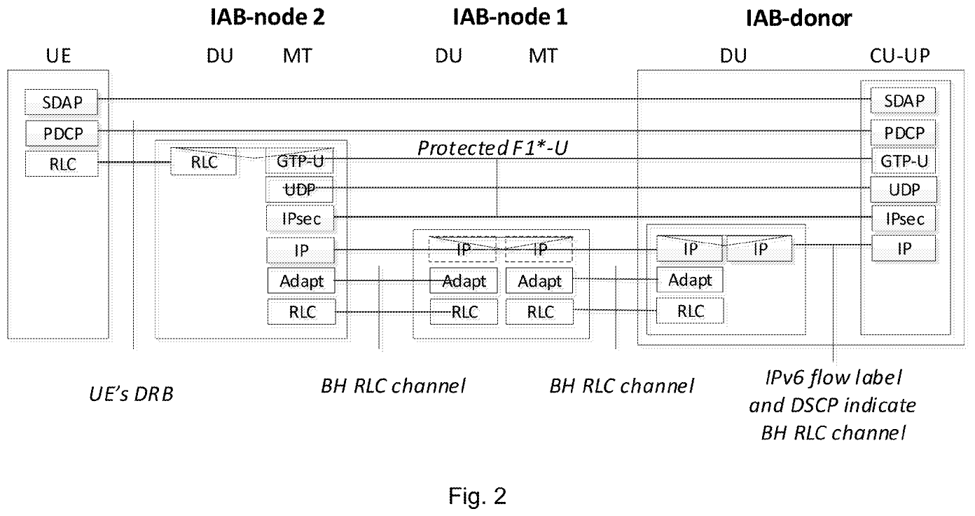

FIGS. 3A-C are block diagrams illustrating a baseline control plane (CP) protocol stack for IAB.

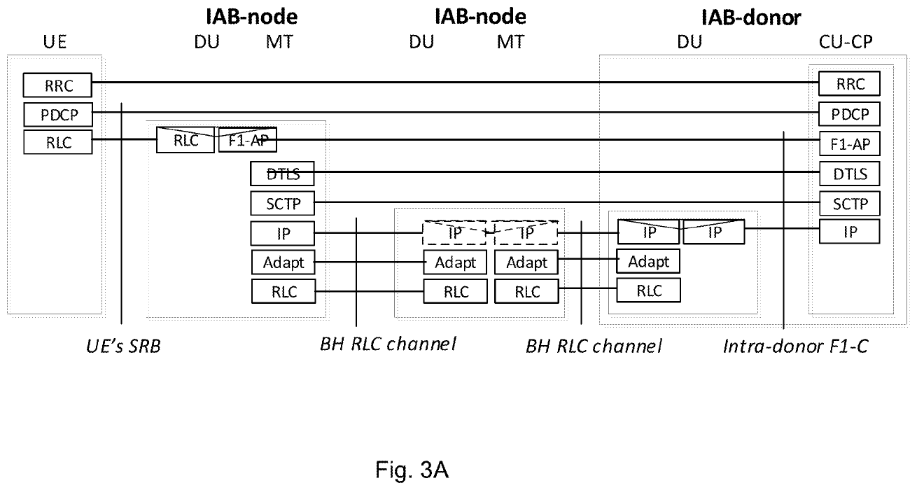

FIG. 4 illustrates a sample header for a data protocol data unit (PDU);

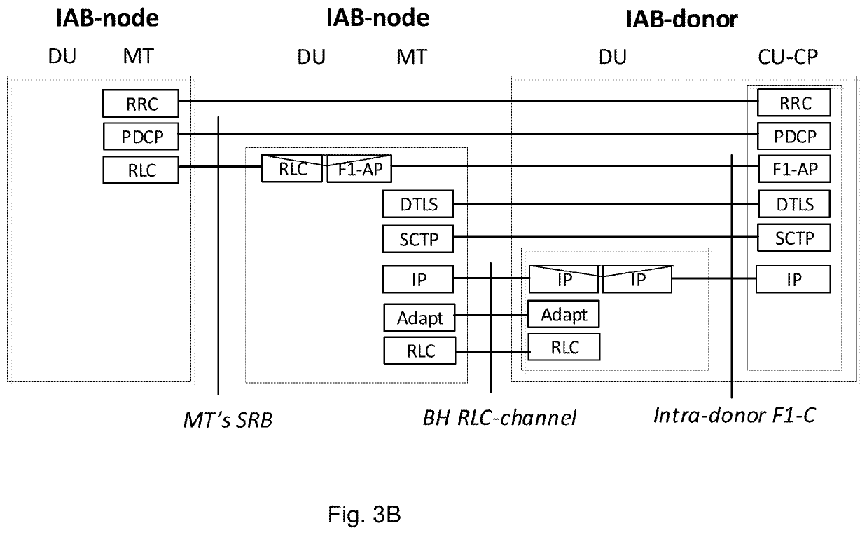

FIG. 5 illustrates an example of bearer mapping in IAB nodes for downstream transmission;

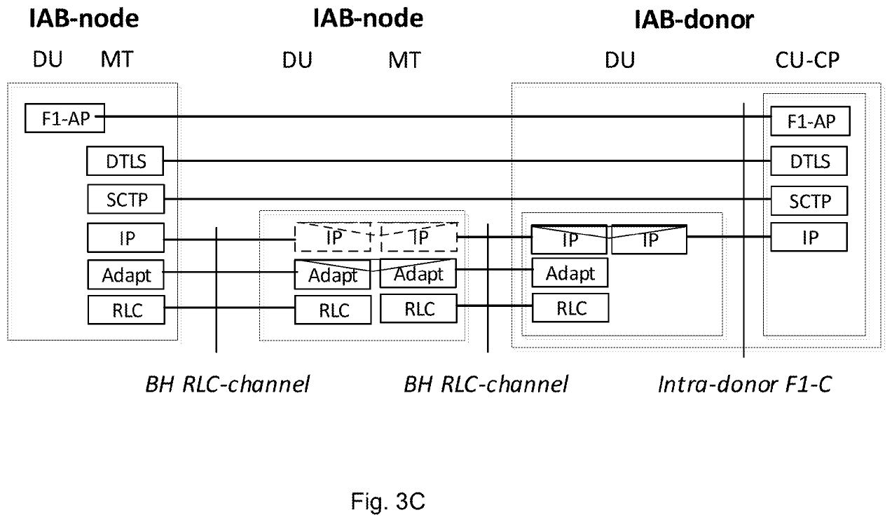

FIG. 6 illustrates an example of the functions performed by Backhaul Adaptation Protocol (BAP) entities for downstream transmission;

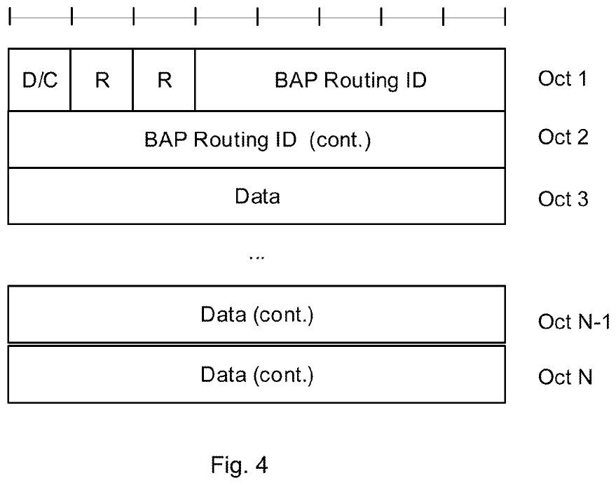

FIG. 7 is an example of bearer mapping in IAB nodes for upstream transmission;

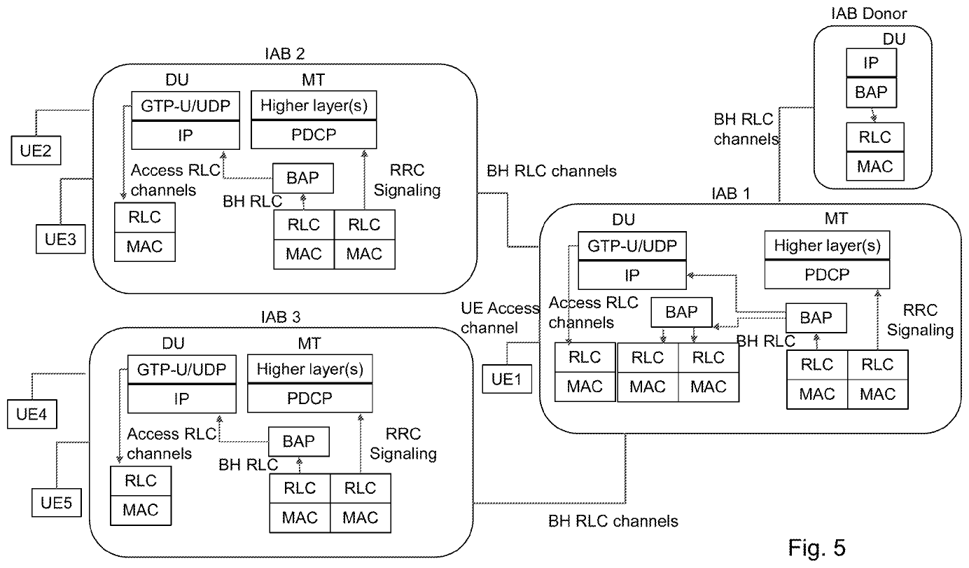

FIG. 8 is an example of the functions performed by BAP entities for upstream transmission;

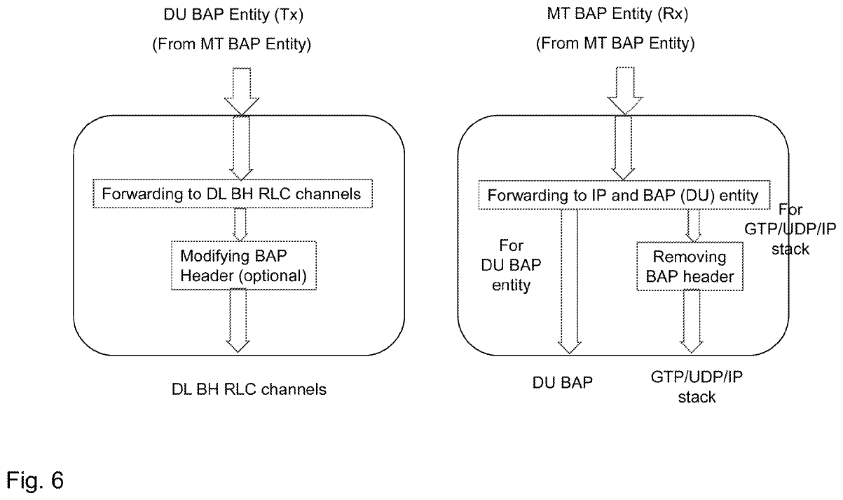

FIG. 9 illustrates an IAB network prior to configuration of dual connectivity;

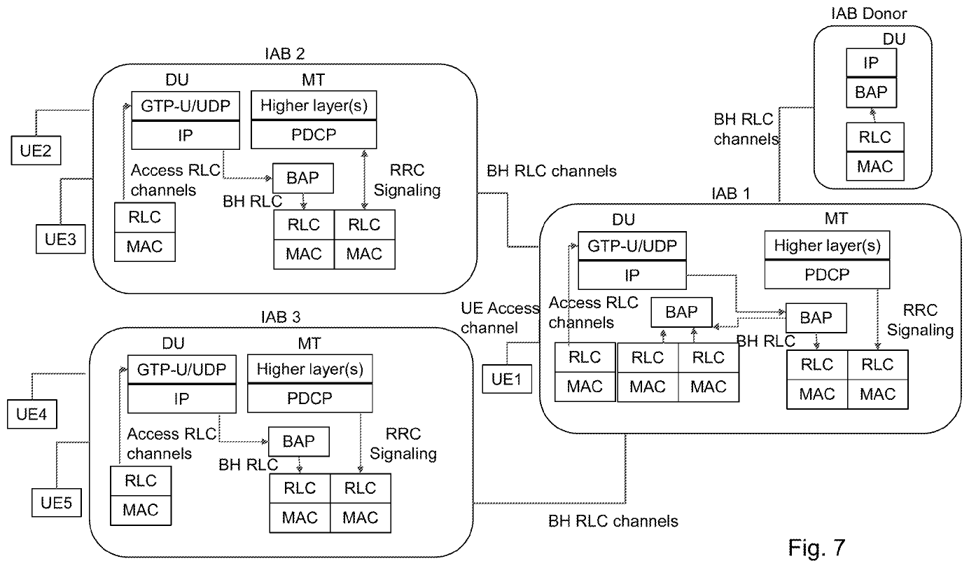

FIG. 10 illustrates an IAB network with dual connectivity for an IAB node;

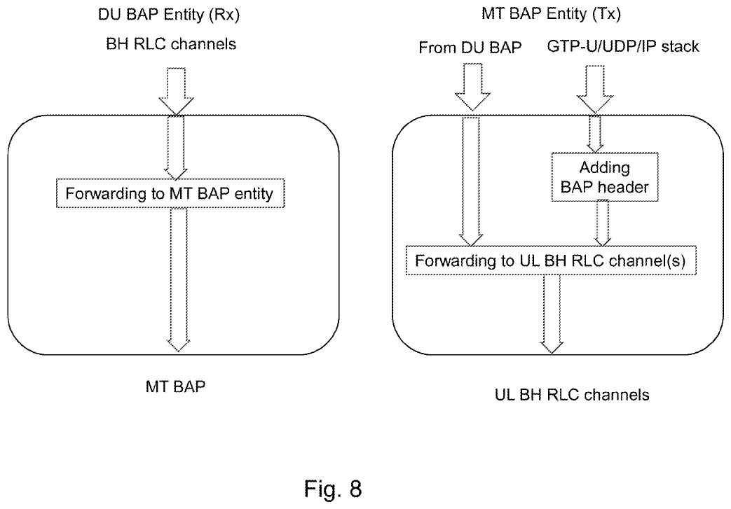

FIG. 11 illustrates an IAB network with a child IAB node connected to a parent IAB node with dual connectivity;

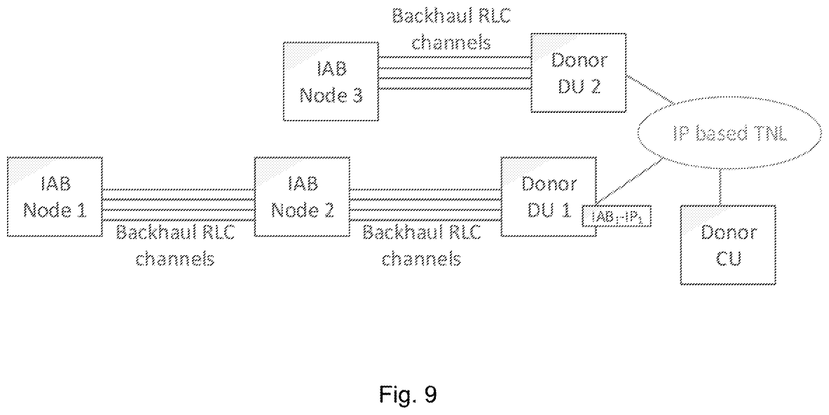

FIG. 12 is a block diagram illustrating an example wireless network;

FIG. 13 illustrates an example user equipment, according to certain embodiments;

FIG. 14 is flowchart illustrating an example method in a network node, according to certain embodiments;

FIG. 15 is a flowchart illustrating another example method in a network node, according to certain embodiments;

FIG. 16 illustrates a schematic block diagram of a network node in a wireless network, according to certain embodiments;

FIG. 17 illustrates an example virtualization environment, according to certain embodiments;

FIG. 18 illustrates an example telecommunication network connected via an intermediate network to a host computer, according to certain embodiments;

FIG. 19 illustrates an example host computer communicating via a base station with a user equipment over a partially wireless connection, according to certain embodiments;

FIG. 20 is a flowchart illustrating a method implemented, according to certain embodiments;

FIG. 21 is a flowchart illustrating a method implemented in a communication system, according to certain embodiments;

FIG. 22 is a flowchart illustrating a method implemented in a communication system, according to certain embodiments; and

FIG. 23 is a flowchart illustrating a method implemented in a communication system, according to certain embodiments.

### DETAILED DESCRIPTION

As described above, certain challenges currently exist with path assignment in integrated access and backhaul (IAB) networks. For example, an IAB node may be several hops away from the IAB donor central unit (CU), where it could theoretically reach or communicate with the IAB donor CU via different paths. Some of the paths may be congested/overloaded and will take longer time for transferring the F1 setup message. However, there is no mechanism for the IAB donor CU to indicate to an IAB node which primary path to use for sending F1 setup request and the subsequent F1-C communication between the two nodes.

Certain aspects of the present disclosure and their embodiments may provide solutions to these or other challenges. For example, particular embodiments enable the IAB donor CU to indicate a primary/suitable F1-C path to the IAB node. In general, particular embodiments include signaling to configure the primary/optimal path for F1-C communication carried over an IAB network.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The embodiments and examples described herein assume that the IAB donor CU is split into one or more IAB donor CU user planes (Ups) and an IAB donor CU control plane (CP). When the IAB donor CU is not split, the functionalities described herein for the IAB donor CU CP apply for the IAB donor CU. The terms “F1-C” and “F1-AP” are used interchangeably herein. Some embodiments and examples described herein are focused on initial F1-C. However, as described in some of the embodiments, the embodiments described herein are equally applicable to other types of traffic such as user plane traffic and operations, administration, and management (OAM), etc.

Some embodiments include communication between IAB donor CU CP and IAB node. Particular embodiments include a method at the gNB CU CP configured as an IAB donor CU CP for IAB nodes. The method comprises sending the following information to the IAB node. The information may include the mapping between initial F1-C connection signaling and one or more backhaul adaptation protocol (BAP) routing ID(s) to be used for carrying the F1-C traffic. This may be communicated to the IAB node via radio resource control (RRC) signaling.

Particular embodiments include a method at an IAB node. The method comprises receiving the mapping between initial F1-C signaling and the BAP routing ID(s). This could be communicated from the IAB donor CU CP via RRC signaling. This could be communicated from another node in the network, such as OAM node. This could be directly configured/hard-coded in the IAB node. This could be specified in a standard in 3GPP or IETF.

Based on the received/configured mapping between initial F1-C signaling and BAP routing ID(s), the method further comprises mapping initial uplink F1-C packets to the primary/default path, based on the BAP routing ID indicated in the received RRC message from the IAB donor CU and selecting a backup path for uplink traffic, based on the BAP routing ID indicated in the received configuration UE context management message from the IAB donor CU.

In some embodiments, the IAB donor CU CP explicitly indicates to the IAB node the primary/default path to be used for the F1-C connection. In some embodiments, the IAB donor CU CP configures a secondary (i.e., backup) path to be used in case of failure on links that carry the primary F1-C connection.

In particular embodiments, the secondary path can be via the same or different IAB donor distributed unit (DU) as the primary path. The secondary path may be to another IAB donor CU CP.

In particular embodiments, the primary/default path can be used not only for the initial F1-C signaling, but also for any other traffic, be it control plane or user plane, if the IAB node does not find a matching information for that traffic in its routing table.

In particular embodiments, several default paths can be specified, where each default path is for a specific traffic type. For example, there could be one default path for F1-C traffic, another one for F1-U traffic, another for OAM traffic, another for LTE traffic that is being routed, another for non-3GPP traffic, etc.

In particular embodiments, each path available to the IAB node may be assigned a priority, where the primary path has the highest priority, and the least preferable path (e.g., a path that is realized via nodes that are leased from other operators) with the lowest priority. The IAB node then, when having to route a packet that does not have a matching route configured in the routing table, will try to use the primary path first, and if that is not possible or does not perform as expected, will choose the second highest priority path, and so on.

Some embodiments include RRC signaling for the IAB donor CU CP to communicate to the IAB node in the BAP configuration, which IPv4 addresses or IPv6 prefix has been allocated for each path. In some embodiments, the communication of the default path can be made by the example message described below.

The RRCReconfiguration message is the command to modify an RRC connection. It may convey information for measurement configuration, mobility control, radio resource configuration (including RBs, MAC main configuration and physical channel configuration) and AS security configuration.

Signaling radio bearer: SRB1 or SRB3
RLC-SAP: AM
Logical channel: DCCH
Direction: Network to UE
RRCReconfiguration message

-- ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |
| } | |
| } | |
| RRCReconfiguration-IEs ::= | SEQUENCE { |
| radioBearerConfig | RadioBearerConfig |
| OPTIONAL, -- Need M | |
| secondaryCellGroup | OCTET STRING (CONTAINING |
| CellGroupConfig) | OPTIONAL, --Need M |
| measConfig | MeasConfig |
| OPTIONAL, -- Need M | |
| lateNonCriticalExtension | OCTET STRING |
| OPTIONAL, | |
| nonCriticalExtension | RRCReconfiguration-v1530-IEs |
| OPTIONAL | |
| } | |
| RRCReconfiguration-v1530-IEs ::= | SEQUENCE { |
| masterCellGroup | OCTET STRING (CONTAINING |
| CellGroupConfig) | OPTIONAL, -- Need M |
| fullConfig | ENUMERATED {true} |
| OPTIONAL, -- Cond FullConfig | |
| dedicatedNAS-MessageList | SEQUENCE (SIZE(1..maxDRB)) OF |
| DedicatedNAS-Message | OPTIONAL, -- Cond nonHO |
| masterKeyUpdate | MasterKeyUpdate |
| OPTIONAL, -- Cond MasterKeyChange | |
| dedicatedSIB1-Delivery | OCTET STRING (CONTAINING SIB1) |
| OPTIONAL, -- Need N | |
| dedicatedSystemInformationDelivery | OCTET STRING (CONTAINING |
| SystemInformation) | OPTIONAL, -- Need N |
| otherConfig | OtherConfig |
| OPTIONAL, -- Need M | |
| nonCriticalExtension | RRCReconfiguration-v1540-IEs |
| OPTIONAL | |
| } | |
| RRCReconfiguration-v1540-IEs ::= | SEQUENCE { |
| otherConfig-v1540 | OtherConfig-v1540 |
| OPTIONAL, -- Need M | |
| nonCriticalExtension | RRCReconfiguration-v1560-1Es |
| OPTIONAL | |
| } | |
| RRCReconfiguration-v1560-IEs ::= | SEQUENCE { |
| mrdc-SecondaryCellGroupConfig | SetupRelease { MRDC- |
| SecondaryCellGroupConfig } | OPTIONAL, -- Need M |
| radioBearerConfig2 | OCTET STRING (CONTAINING |
| RadioBearerConfig) | OPTIONAL, -- Need M |
| sk-Counter | SK-Counter |
| OPTIONAL, -- Need N | |
| nonCriticalExtension | RRCReconfiguration-v16xy |
| OPTIONAL | |
| } | |
| RRCReconfiguration-v16xy-IEs ::= | SEQUENCE { |
| bap-Config-r16 | BAP-Config-r16 |
| OPTIONAL, -- Need M | |
| nonCriticalExtension | SEQUENCE { } |
| OPTIONAL | |
| } | |
| BAP-Config-r16 ::= | SEQUENCE { |
| bap-Address-r16 | FFS |
| | OPTIONAL, |
| ul-Routing-Configuration | FFS |
| | OPTIONAL, |
| ul-BearerMapping-Configuration | FFS |
| | OPTIONAL, |
| iab-PathList | IAB-PathList |
| | OPTIONAL, |
| . . . , | |
| defaultPath | INTEGER (1..maxIABPaths) OPTIONAL |
| } | |
| IAB-PathList ::= | SEQUENCE (SIZE (1..maxIABPaths)) OF IAB-Path |
| IAB-Path ::= | SEQUENCE { |
| iab-IP-Allocation | IAB-IP-Allocation |
| OPTIONAL, | |
| ul-BAP-Routing-ID | BIT STRING (SIZE (13) ) , |
| cellGroup | ENUMERATED {mcg, scg}, |
| . . . | |
| } | |
| IAB-IP-Allocation ::= | SEQUENCE { |
| Ip-type | CHOICE { |
| ipv4-List | IPv4-List, |
| ipv6-Prefix | BIT STRING (SIZE (64)) |
| } | |
| } | |
| IPv4-List : := | SEQUENCE (SIZE (1..maxIPv4)) OF BIT STRING (SIZE |
| (32) ) | |
| MRDC-SecondaryCellGroupConfig : : = | SEQUENCE { |
| mrdc-ReleaseAndAdd | ENUMERATED {true} |
| OPTIONAL, -- Need N | |
| mrdc-SecondaryCellGroup | CHOICE { |
| nr-SCG | OCTET STRING (CONTAINING |
| RRCReconfiguration) , | |
| eutra-SCG | OCTET STRING |
| } | |
| } | |
| MasterKeyUpdate ::= | SEQUENCE { |
| keySetChangeIndicator | BOOLEAN, |
| nextHopChainingCount | NextHopChainingCount |
| nas-Container | OCTET STRING |
| OPTIONAL, -- Cond securityNASC | |
| . . . | |
| } | |

-- TAG-RRCRECONFIGURATION-STOP

-- ASNISTOP

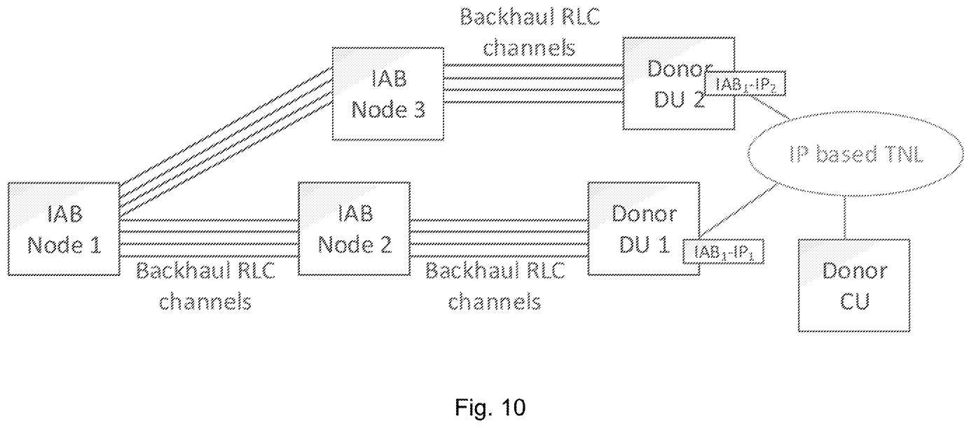

FIG. 12 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 12, network node 160 includes processing circuitry 170, device readable medium 180, interface 190, auxiliary equipment 184, power source 186, power circuitry 187, and antenna 162. Although network node 160 illustrated in the example wireless network of FIG. 12 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 12 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NF, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 12. For simplicity, the wireless network of FIG. 12 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

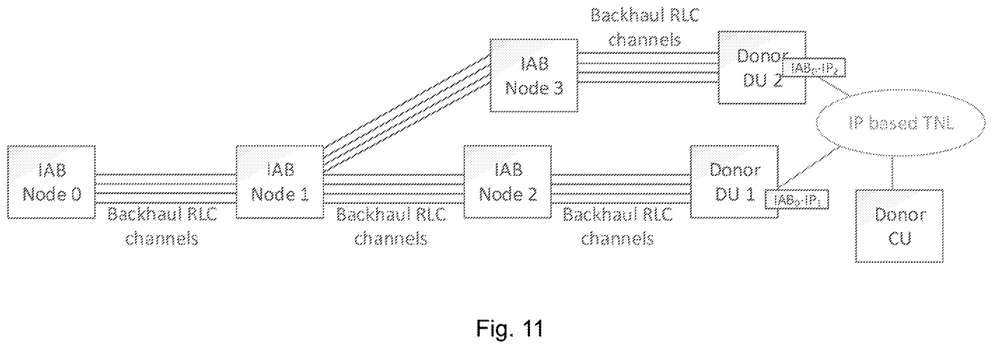

FIG. 13 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 13, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 13 is a UE, the components discussed herein are equally applicable to a WD, and vice-versa.

In FIG. 13, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 13, or only a subset of the components. The level of integration between the components may vary from one UE to another UE. Further, certain UEs may contain multiple instances of a component, such as multiple processors, memories, transceivers, transmitters, receivers, etc.

In FIG. 13, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 13, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 13, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

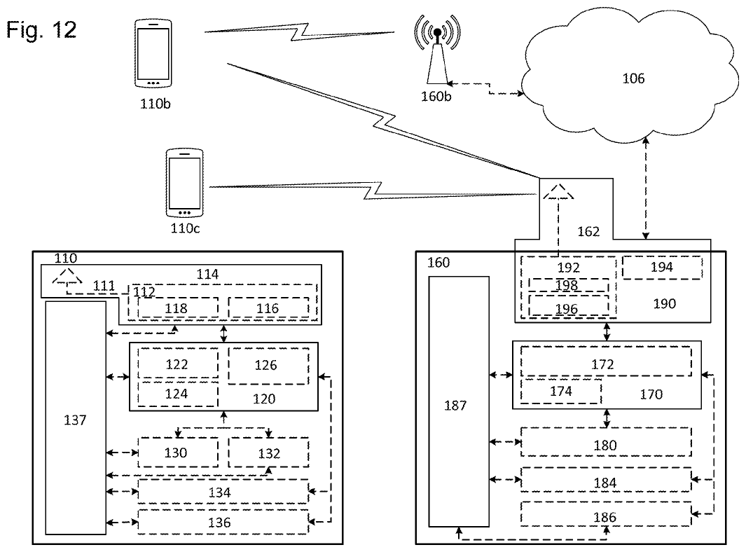

FIG. 14 is a flowchart illustrating an example method in a network node, according to certain embodiments. In particular embodiments, one or more steps of FIG. 14 may be performed by network node 160 described with respect to FIG. 12. The network node comprises an IAB donor CU.

The method begins at step 1412, where the network node (e.g., network node 160) obtains mapping(s) between a traffic type and a communication path. The communication path is for communicating the traffic type between the IAB donor CU network node and an IAB network node. The mapping(s) may include any of the mappings described in the embodiments and examples above. For example, the mapping may include a default path for initial F1-C traffic. The mapping may include more than one mapping. For example, the mapping may include a primary path and a secondary path for F1-C traffic. The mapping(s) may include a default and/or primary/secondary paths for a first traffic type and another default and/or primary/secondary path for a second traffic type.

The mapping between the traffic type and the communication path may be indicated according to various embodiments. In some embodiments, the mapping may be represented by an explicit traffic type (e.g., F1-C traffic) and the communication path may be represented by a BAP routing ID. In some embodiments, the traffic type may be an implied traffic type, such as a default traffic type, where any traffic types without an explicit mapping may be routed over the associated communication path. The traffic types may comprise enumerated types, integers, or any other suitable indicator of traffic type. The communication path may be represented by an identifier, such as a BAP routing ID, or any other suitable identifier.

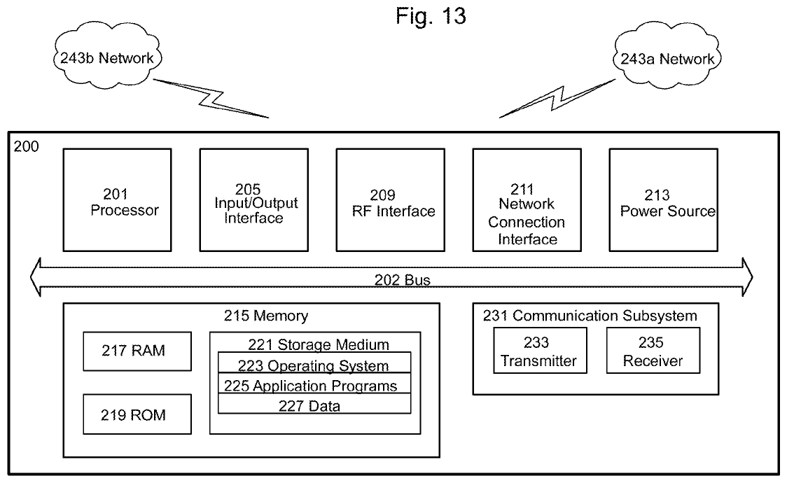

At step 1414, the network node transmits (e.g., RRC signaling) the mapping(s) to the IAB network node. The IAB network node uses the mappings to route traffic, as described with respect to FIG. 15.

Modifications, additions, or omissions may be made to method 1400 of FIG. 14. Additionally, one or more steps in the method of FIG. 14 may be performed in parallel or in any suitable order.

FIG. 15 is a flowchart illustrating another example method in a network node, according to certain embodiments. In particular embodiments, one or more steps of FIG. 15 may be performed by network node 160 described with respect to FIG. 12. The network node comprises an IAB node.

The method begins at step 1512, where the network node (e.g., network node 160) obtains mapping(s) between a traffic type and a communication path. The communication path is for communicating the traffic type between a IAB donor CU network node and the IAB network node. The mapping(s) may include any of the mappings described in the embodiments and examples above. For example, the mapping may include the mappings described with respect to step 1412 of FIG. 14.

At step 1514, the network node transmits a communication of the traffic type to the IAB donor CU network node using the communication path, according to any of the embodiments and examples described above. For example, transmitting to the IAB node may comprise including a BAP routing ID received in the obtained mapping for the traffic type in a BAP header of the communication packet.

Modifications, additions, or omissions may be made to method 1500 of FIG. 15. Additionally, one or more steps in the method of FIG. 15 may be performed in parallel or in any suitable order.

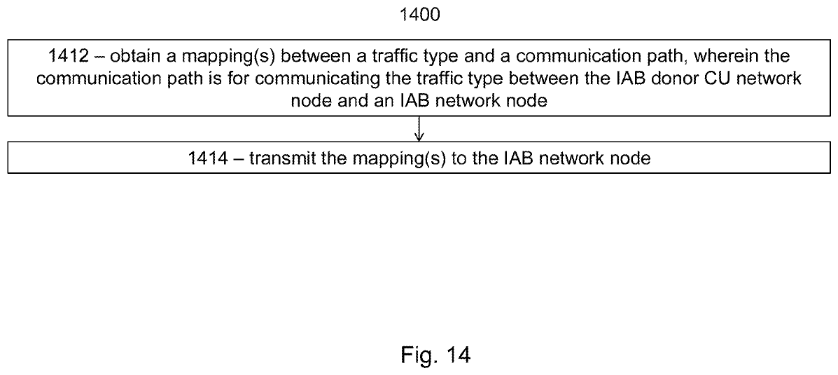

FIG. 16 illustrates a schematic block diagram of an apparatus in a wireless network (for example, the wireless network illustrated in FIG. 12). The apparatus may comprise a network node (e.g., network node 160 in FIG. 12). Apparatus 1600 is operable to carry out the example methods described with reference to FIGS. 14 and 15. Apparatus 1600 may be operable to carry out other processes or methods disclosed herein. It is also to be understood that the methods of FIGS. 14 and 15 are not necessarily carried out solely by apparatus 1600. At least some operations of the method can be performed by one or more other entities.

Virtual apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause obtaining module 1602, transmitting module 1604, and any other suitable units of apparatus 1600 to perform corresponding functions according one or more embodiments of the present disclosure.

As illustrated in FIG. 16, apparatus 1600 includes obtaining module 1602 configured to obtain mappings between traffic types and communication paths, according to any of the embodiments and examples described herein. Transmitting module 1604 is configured to transmit the mappings from a IAB donor node CU to an IAB node and to transmit traffic from the IAB node to the IAB donor node CU based on the mappings, according to any of the embodiments and examples described herein.

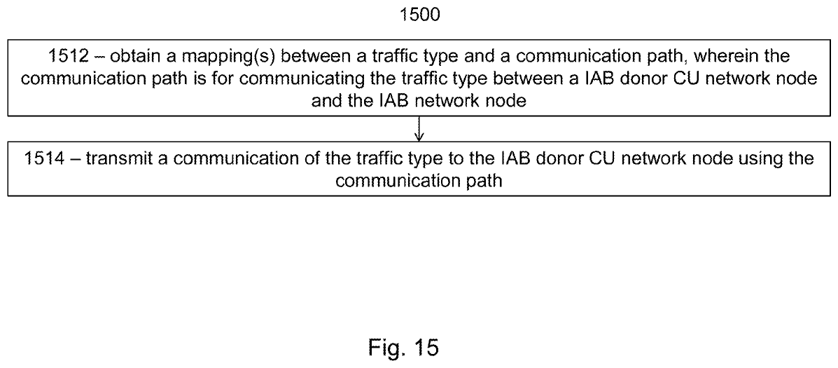

FIG. 17 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 17, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

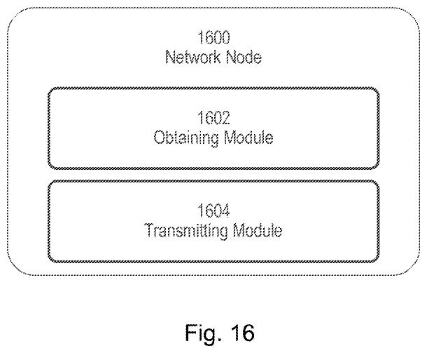

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

With reference to FIG. 18, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 18 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

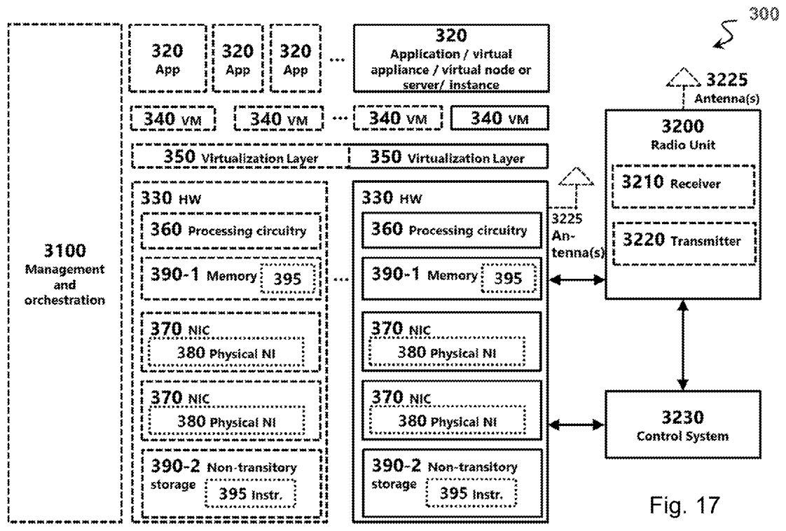

FIG. 19 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 19. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 19) served by base station 520. Communication interface 526 may be configured to facilitate connection 560 to host computer 510. Connection 560 may be direct, or it may pass through a core network (not shown in FIG. 19) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 19 may be similar or identical to host computer 430, one of base stations 412a, 412b, 412c and one of UEs 491, 492 of FIG. 18, respectively. This is to say, the inner workings of these entities may be as shown in FIG. 19 and independently, the surrounding network topology may be that of FIG. 18.

In FIG. 19, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

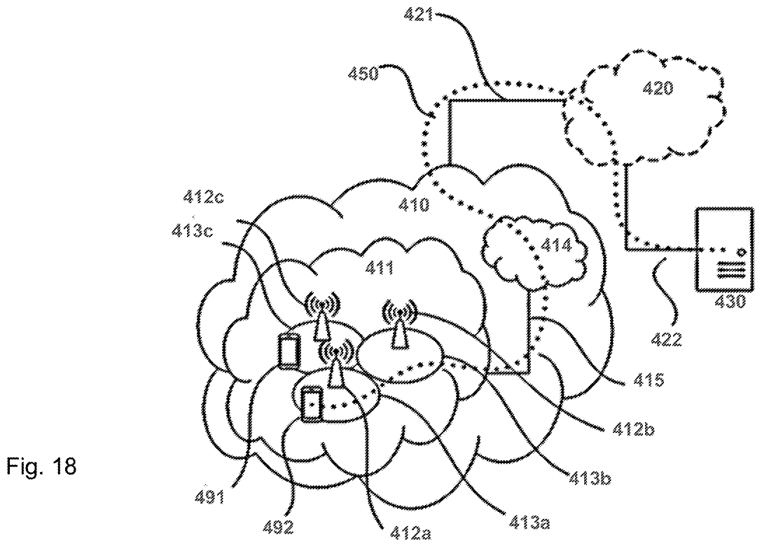

FIG. 20 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 20 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

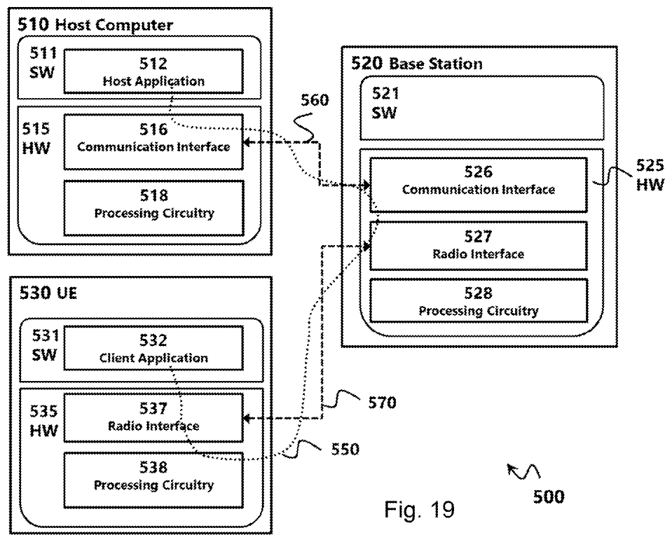

FIG. 21 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 21 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

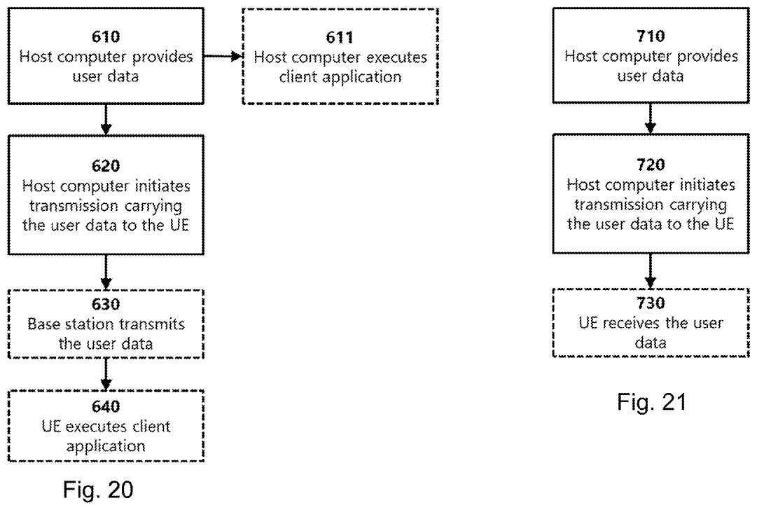

FIG. 22 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 22 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

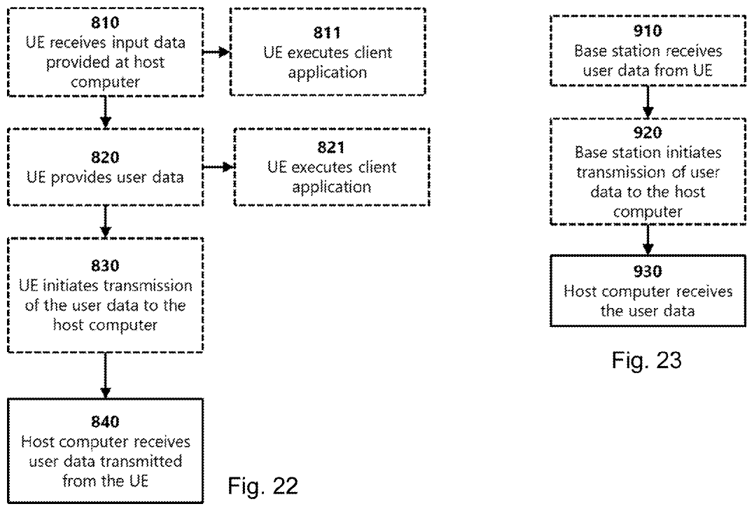

FIG. 23 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 23 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 1xRTT | CDMA2000 1x Radio Transmission Technology |
| 3GPP | 3rd Generation Partnership Project |
| 5G | 5th Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH Ec/No | CPICH Received energy per chip divided |
| | by the power density in the band |
| CQI | Channel Quality information |
| C-RNTI | Cell RNTI |
| CSI | Channel State Information |
| DC | Dual Connectivity |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| E-SMLC | Evolved-Serving Mobile Location Centre |
| ECGI | Evolved CGI |
| eNB | E-UTRAN NodeB |
| ePDCCH | enhanced Physical Downlink Control Channel |
| E-SMLC | evolved Serving Mobile Location Center |
| E-UTRA | Evolved UTRA |
| E-UTRAN | Evolved UTRAN |
| FDD | Frequency Division Duplex |
| GERAN | GSM EDGE Radio Access Network |
| gNB | Base station in NR |
| GNSS | Global Navigation Satellite System |
| GPS | Global Positioning System |
| GSM | Global System for Mobile communication |
| HARQ | Hybrid Automatic Repeat Request |
| HO | Handover |
| HSPA | High Speed Packet Access |
| HRPD | High Rate Packet Data |
| IAB | Integrated Access and Backhaul |
| LTE | Long-Term Evolution |
| MAC | Medium Access Control |
| MBMS | Multimedia Broadcast Multicast Services |
| MBSFN | Multimedia Broadcast multicast service Single Frequency Network |
| MBSFN ABS | MBSFN Almost Blank Subframe |
| MIB | Master Information Block |
| MME | Mobility Management Entity |
| MSC | Mobile Switching Center |
| NR | New Radio |
| OFDM | Orthogonal Frequency Division Multiplexing |
| OFDMA | Orthogonal Frequency Division Multiple Access |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDSCH | Physical Downlink Shared Channel |
| PGW | Packet Gateway |
| PHICH | Physical Hybrid-ARQ Indicator Channel |
| PLMN | Public Land Mobile Network |
| PRACH | Physical Random Access Channel |
| PSS | Primary Synchronization Signal |
| PUCCH | Physical Uplink Control Channel |
| PUSCH | Physical Uplink Shared Channel |
| RA | Random Access |
| RACH | Random Access Channel |
| QAM | Quadrature Amplitude Modulation |
| RAN | Radio Access Network |
| RAT | Radio Access Technology |
| RLM | Radio Uink Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDU | Service Data Unit |
| SFN | System Frame Number |
| SGW | Serving Gateway |
| SI | System Information |
| SIB | System Information Block |
| SNR | Signal to Noise Ratio |
| SS | Synchronization Signal |
| SSS | Secondary Synchronization Signal |
| TDD | Time Division Duplex |
| TTI | Transmission Time Interval |
| UE | User Equipment |
| UL | Uplink |
| UMTS | Universal Mobile Telecommunication System |
| USIM | Universal Subscriber Identity Module |
| UTDOA | Uplink Time Difference of Arrival |
| UTRA | Universal Terrestrial Radio Access |
| UTRAN | Universal Terrestrial Radio Access Network |
| WCDMA | Wide CDMA |
| WEAN | Wide Local Area Network |

1. A method performed by an integrated access and backhaul (IAB) donor control unit (CU) network node, the method comprising:
obtaining a first mapping between a first traffic type and a first communication path, wherein the first communication path is for communicating the first traffic type between the IAB donor CU network node and an IAB network node; and
transmitting the first mapping to the IAB network node.

2.-11. (canceled)

12. An integrated access and backhaul (IAB) donor control unit (CU) network node comprising processing circuitry operable to:
obtain a first mapping between a first traffic type and a first communication path, wherein the first communication path is for communicating the first traffic type between the IAB donor CU network node and an IAB network node; and
transmit the first mapping to the IAB network node.

13. The network node of claim 12, the processing circuitry further operable to:
obtain a second mapping between a second traffic type and a second communication path, wherein the second communication path is for communicating the second traffic type between the IAB donor CU network node and the IAB network node; and
transmit the second mapping to the IAB network node.

14. The network node of claim 13, wherein the first communication path includes a first IAB donor distributed unit (DU) and the second communication path also includes the first IAB donor DU.

15. The network node of claim 13, wherein the first communication path includes a first IAB donor distributed unit (DU) and the second communication path includes a second IAB donor DU different from the first IAB donor DU.

16. The network node of claim 13, wherein the first traffic type and the second traffic type are the same traffic type and the first communication path comprises a primary communication path and the second communication path comprises a secondary communication path.

17. The network node of claim 13, wherein the first traffic type and the second traffic type are different traffic types and the first communication path comprises a primary communication path for the first traffic type and the second communication path comprises a primary communication path for the second traffic type.

18. The network node of claim 12, wherein the first traffic type comprises F1-C traffic.

19. The network node of claim 12, wherein the first traffic type comprises a plurality of traffic types.

20. The network node of claim 12, wherein the first traffic type comprises a default traffic type.

21. The network node of claim 12, wherein the first communication path is identified by a backhaul adaptation protocol (BAP) route identifier.

22. The network node of claim 12, wherein the processing circuitry is operable to transmit the first mapping to the IAB network node using radio resource control (RRC) signaling.

23. A method performed by an integrated access and backhaul (IAB) network node, the method comprising:
obtaining a first mapping between a first traffic type and a first communication path, wherein the first communication path is for communicating the first traffic type between an IAB donor CU network node and the IAB network node; and
transmitting a communication of the first traffic type to the IAB donor CU network node using the first communication path.

24.-34. (canceled)

35. An integrated access and backhaul (IAB) network node comprising processing circuitry operable to:
obtain a first mapping between a first traffic type and a first communication path, wherein the first communication path is for communicating the first traffic type between an IAB donor CU network node and the IAB network node; and
transmit a communication of the first traffic type to the IAB donor CU network node using the first communication path.

36. The network node of claim 35, wherein the processing circuitry is operable to obtain the first mapping by receiving the first mapping from the IAB donor CU network node.

37. The network node of claim 36, wherein the processing circuitry is operable to receive the first mapping from the IAB donor CU network node by receiving radio resource control (RRC) signaling.

38. The network node of claim 35, the processing circuitry further operable to:
obtain a second mapping between a second traffic type and a second communication path, wherein the second communication path is for communicating the second traffic type between the IAB donor CU network node and the IAB network node; and
transmit a communication of the second traffic type to the IAB donor CU network node using the second communication path.

39. The network node of claim 38, wherein the first communication path includes a first IAB donor distributed unit (DU) and the second communication path also includes the first IAB donor DU.

40. The network node of claim 38, wherein the first communication path includes a first IAB donor distributed unit (DU) and the second communication path includes a second IAB donor DU different from the first IAB donor DU.

41. The network node of claim 38, wherein the first traffic type and the second traffic type are the same traffic type and the first communication path comprises a primary communication path and the second communication path comprises a secondary communication path.

42. The network node of claim 38, wherein the first traffic type and the second traffic type are different traffic types and the first communication path comprises a primary communication path for the first traffic type and the second communication path comprises a primary communication path for the second traffic type.

43. The network node of claim 35, wherein the first traffic type comprises F1-C traffic.

44. The network node of claim 35, wherein the first traffic type comprises a plurality of traffic types.

45. The network node of claim 35, wherein the first traffic type comprises a default traffic type.

46. The network node of claim 35, wherein the first communication path is identified by a backhaul adaptation protocol (BAP) route identifier.
